(19) United States
(12) Patent Application Publication
(10) Pub. No.: US 2014/0118112 A1
(43) Pub. Date: May 1, 2014

(54) Conversion of Alert Messages for Dissemination in a Program Distribution Network

(71) Applicant: Thomson Licensing, Issy de Moulineaux (FR)

(72) Inventors: Michael Anthony Pugel, Noblesville, IN (US); David Emery Virag, Indianapolis, IN (US)

(73) Assignee: Thomson Licensing, Issy de Moulineaux (FR)

(21) Appl. No.: 14/146,542

(22) Filed: Jan. 2, 2014

Related U.S. Application Data
(63) Continuation of application No. 10/534,450, filed on May 10, 2005, now abandoned.
(60) Provisional application No. 60/425,611, filed on Nov. 12, 2002.

(51) Int. Cl. G08B 27/00

(52) U.S. Cl. CPC G08B 27/00
USPC 340/7.58

(57) ABSTRACT

A system for inserting alert based information into broadcast programming over a program distribution network. A program distributor transmits broadcast programming over program distribution network via a network fabric. When program distributor receives alert based information, the program distributor converts the alert information from a first format to a second format compatible with the broadcast programming and the program distributor inserts the converted alert into a signal carrying the broadcast programming via the network fabric. A method is also disclosed for inserting alert based information into a broadcast programming transmitted over a program distribution network.

### PRIORITY

This application claims the benefit, under 35 U.S.C. 120 as a continuation of co-pending U.S. patent application Ser. No. 10/534,450, filed on May 10, 2005, which claims the benefit under 35 U.S.C. 365 of International Application PCT/US03/26648, filed Aug. 25, 2003, which was published in accordance with PCT Article 21(2) on May 27, 2004 in English, and which claims the benefit of United States provisional patent application No. 60/425,611, filed Nov. 12, 2002.

### FIELD OF INVENTION

The invention is related to the field of program distribution networks, in particular program distribution networks that deliver alert messages.

### BACKGROUND OF THE INVENTION

Unpredictable events such as weather storms, seismic activity or even terrorist attacks are dangerous situations that affect the safety and well being of bystanders. During these types of events the extent of injuries and property damage would be minimized if a warning were disseminated to an affected bystander in a timely manner.

Most distributed broadcasting or program distribution networks, such as a cable network, satellite network, over the airwaves broadcast network, broadband network, and the like broadcast content such as radio or television programming that is disseminated through the use of local broadcast systems such as local affiliates. Typically, such local networks are able to broadcast warning messages when emergency circumstances arise. Such alert systems are limited because emergency broadcast information is not listened to or viewed, if a device used to receive such messages from a broadcaster is inactive or not tuned to the broadcaster transmitting such a message. Furthermore, with media consolidation and the elimination of independent local broadcast affiliates, more broadcast programming (also known as broadcasting programming) will originate and be controlled from a nationally based broadcast network instead of the level of the local broadcaster. Hence, more people will be receiving media programming from national sources such as EchoStar™ or DirecTV™ than from local sources (a local news affiliate) that deliver national instead of locally related programming. The national broadcaster therefore may lack the means to deliver an emergency message to a local audience, without interrupting a nationally based broadcast.

Also, national broadcasters may have difficulty delivering emergency messages. Such a message would have to be received at the central location of the national broadcaster before the message would be transmitted to local affiliates. In contrast, a local affiliate would have a quicker response time in delivering a message about an emergency because a local affiliate is probably closer in distance to a local user than the national broadcaster.

Therefore, a need exists for a system and method, which permits emergency information to reach an end user or potential victim effectively. A further need exists for a system and method, which also alerts individuals, which are not viewing or listening to a media channel/station.

### SUMMARY OF THE INVENTION

The invention includes a program distributor that distributes programming to users via a data network. The program distributor processes a received alert message from a source into a format that is capable of being distributed to users as part of regular broadcast programming. Such a received alert message is optionally annotated with supplemental information.

### BRIEF DESCRIPTION OF DRAWINGS

FIG. 1 is a schematic diagram of a system for alerting individuals of an event in accordance with one embodiment of the present invention;

FIG. 2 is a block diagram of a receiver employed in accordance with the present invention to alert individuals of an event;

FIG. 3 is a graph of a vertical blanking interval waveform for inserting analog data relevant to alerting a user of an event in accordance with one embodiment of the present invention;

FIG. 4 is a block diagram of a data packet format for transmitting digital data relevant to alerting a user of an event in accordance with the present invention; and

FIG. 5 is a flowchart illustrating a method of translating an alert message into a format capable of being transmitted in a broadcast signal.

It should be understood that the drawings are for purposes of illustrating the concepts of the invention and are not necessarily the only possible configuration for illustrating the invention.

### DETAILED DESCRIPTION

The preferred embodiment of the invention operates in view of the SAME codes developed by the National Weather Service of the United States, although other types of geographic codes and weather related codes may be used. The SAME message is preferably an ASCII format message that may be around 50 or so bytes long transmitted a format capable of being transmitted in a signal.

The data structure for the SAME message is illustratively shown below in Table I:

TABLE 1

Preamble - Header - Identifier - Event Code - Geographic area
code Purge time -Calendar date/time - Originator - End.
(- dash is sent in between each field code except before purge
time)
Each component of the SAME message may include the following:
Preamble - sixteen bytes of $AB
Header - always ZCZC
Identifier - sent for voice message as WXR, others are possible
Event Code - in a table in standard, three letters
Geographic area code - set up as FIPS, in table can be multiple
codes of 6 letters
Purge time - shows delta from original issue time as a 4-digit
number, used to indicate length of warning time
Calendar time/date - given in numeric Julian format using UTC
Originator - station id call letters
End - sent as NNNN

The letters, e.g., AB, ZCZC, WXR and NNNN designate data codes used for the set-up of a SAME message. These codes may be used to trigger or synchronize a receiver to the data stream. The specific identifier “WXR” says the message is a voice message (voice is available) from the National Weather Service. However, a plurality of sources may be employed and this identifier would allow for other sources to originate the message (through other means as well), and still fit into the present system. The present invention provides a method and system for disseminating event information over a data network (such as a satellite network, cellular network, television broadcast network, cable, modem, digital subscriber line, and the like). Event information may be designated for delivery to particular local areas. These areas may be determined at the information source and/or an intermediary location, for example, a head end network for a cable system or at the destination, for example, in an individual's home. Once the local areas that would be affected the most are determined, the system of the present invention informs a receiver device at the individual locations in the local areas. This notification, transmitted in a signal, provides an audible, visual and/or text alert to inform users that a message or data about an event is being relayed. Then, the data or information is conveyed over the network in accordance with the present invention. The alert signals may be continued or a set duration or continue for the duration of the event.

It is to be understood that the present invention is described in terms of an illustrative cable network system; however, the present invention is much broader and may include any network system, which includes the capability of sending event messages and signaling across a network. For example, the present invention may be employed in any type of data/distributed programming network; the data network transmitting information in a format capable of being sent in a signal. It should also be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces. It

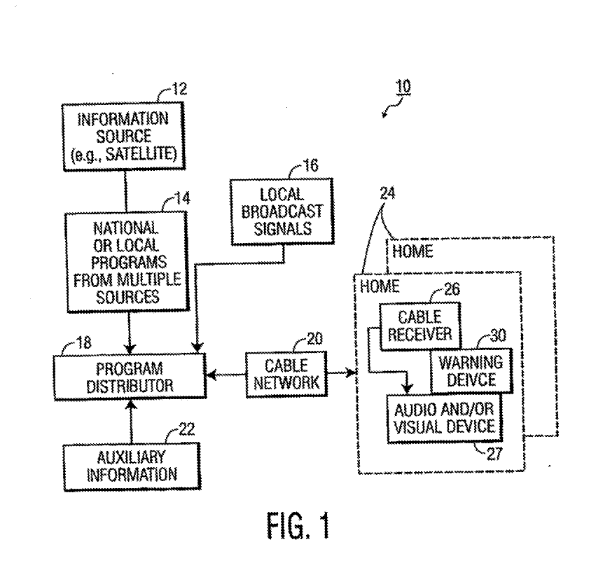

Referring now in specific detail to the drawings in which like reference numerals identify similar or identical elements throughout the several views, and initially to FIG. 1, communication network system 10 is shown in accordance with the present invention.

Communication network 10 as a program distribution network may include one or more information sources 12, which may include satellites, broadcast stations, weather stations, cellular sites or any other transmission source. In the illustrative embodiment, information source(s) 12 provides data and information to program distributor 18. In a preferred embodiment, a satellite network, as information source 12, provides programming 14 to program distributor 18. In addition, program distributor 18 may receive information from multiple sources. For example, cable network program distributor 18 may receive information from local broadcast stations 16, such as local radio stations, from satellites 12, or from auxiliary sources 22, such as telephone or other cable or wireless network.

During an alert situation, such as weather alert or terrorist attack, an agency such as the United States Office of Homeland Security or the National Weather Service will give notification about the event through an alarm notification. Different systems are already known in the art such as the SAME time weather alert system, the Emergency Managers Weather Information Network (EMWIN), National Emergency Alert Notification System (EMCOM); alert systems by created and utilized by the United States Federal Government. These alerts are typically required to be broadcasted by local broadcaster 16 to a user's home location.

In the present invention, the alerts are transmitted to information source 12, instead of just using local broadcaster 16. The alert is encoded as part of the signal used by information source 12 to communicate typical program information. For example, information source 12 is a satellite or cable source that transmits programming and/or information in the form of an MPEG-2 compatible data stream although any other formats of data streams may be used; such data streams are capable of being transmitted in a signal form. The alert is formatted into the auxiliary data fields or headers of packets forming the MPEG-2 data stream, although other sections of a packet may be used. Continuing with the present example, a voice based alert for the New York area with the corresponding SAME geographical code of 034025 is issued by NOAA, which is directly transmitted to information source 12. It should be noted that although SAME information based alerts typically consist of text, types of information such as video, audio, text, a graphic weather map, and the like optionally accompany an SAME alert.

Once the alert is received by information source 12, the voice alert is sampled into a format that allows the alert to be embedded within the MPEG-2 data stream; the sampling operation is performed as known in the art. Data is also added to the data stream noting that the digitized alert corresponds to a SAME geographic code of 034025. Other alerts, such a video or other audio information, are processed similarly, but text based alerts would not typically require such a digitization step.

The data stream is transmitted from information source 12 to a program distributor 18, such as a cable network head end, multiple system operator (MSO), satellite television provider, or point on a broadcast network that receives programming from multiple sources and consolidates such programming for distribution to subscribers downstream from the location of such consolidation. At the point of program distributor 18, a discriminator device is in place that is capable of filtering inserted alert messages in a received data stream from data used for rendering programming such as television shows and music. In the present case, program distributor 18 distributes programming to an audience corresponding to the New York geographic area.

Upon receiving the MPEG-2 data stream, as part of a signal, from information source 12, program distributor 18 parses the embedded alert message from the user data fields present in the data stream. During the parsing operation, program distributor 18 matches the SAME geographic code corresponding to the embedded alert message to its designated subscriber base (as being the New York area).

Upon this match, program distributor 18, reconstitutes embedded alert message into a voice alert that is transmitted to home 24 via cable network 20. Preferably, this voice alert supercedes any other audio transmission being broadcasted over cable network 20. It is to be noted that cable network 20 is an exemplary form of a network fabric, used for transmitting data representing broadcast program and supplementary information from program distributor 18 to home 24 (users). The term network fabric also is used for over the air broadcast networks, wireless based networks, and any other type of network capable of being used to transmit programming. Alternatively, any alert message transmitted by program distributor 18 is rendered as a combination of audio and/or video at the point of home 24.

When transmitting alert messages, program distributor 18 inserts pertinent information from the reporting sources for dissemination within a cable network 20. The pertinent information, such as news of an event or other information can be sent in a number of ways. The signals may be sent, for example, as closed captioning information on analog based channels, the information may be sent in a forward data channel in a network using security, or the information may be sent using some of the bandwidth of the digital channels. Data/information sent over cable network 20 from cable program distributor 18 is sent to user homes 24. Users have a cable or other type of receiver 26, which receives the signals from the cable network, processes the signals and informs/warns the user of the event. The signals received from program distributor 18 are preferably encoded with locality information. This includes information about local areas that are affected by the event.

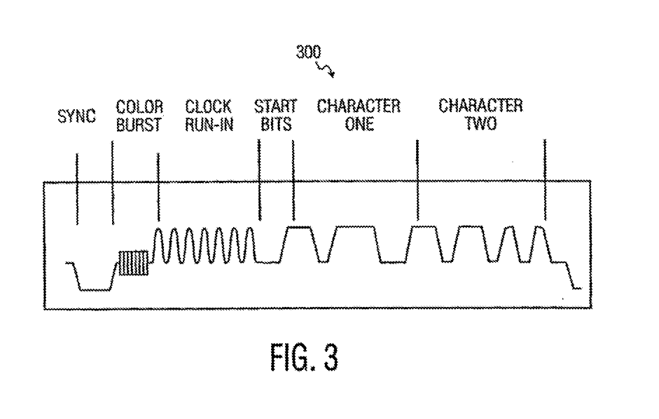

It is noted that information source 12 may comprise any type of information provider (such as a governmental agency, for hire commercial information source, news wire, and the like) that uses a type of modality (such as satellite, broadband, cellular, and the like) to deliver an information message. Information source 12 transmits messages that are typically in a proprietary format requiring proprietary equipment in order to receive and decode such a message. This issue is important when the equipment of a user (such as home user 24) is not compatible with the proprietary format used by information source 12, whereby program distributor 18 makes such a conversion to a format used in cable system 20, as shown in FIG. 3, below.

When communicating alert information from a reporting source to cable network 20, program distributor 18 operates either as a relay of alert information or as an alert author. Specifically, when operating as a relay of alert information, program distributor 18 essentially repeats alert information from a reporting source with very little changes, if any, to the content of the alert information. For example, a reporting source, such as information source 12, communicates a message about an impending thunderstorm for the metropolitan New York area in a SAME format to program distributor 18. This message is converted by program distributor 18 into a format capable of being transmitted in a MPEG-2 data transport stream to homes 24 via cable network 20. The contents of the message concerning a thunderstorm warning for the New York area has not changed in this conversion process.

Alternatively, when program distributor 18 receives the SAME based message, as described above, program distributor 18 adds additional information (supplemental information) to the message to become an alert author. The type of supplemental information added may be audio, video, and/or text information that supplements the alert message. For example, upon receiving the SAME based message, program distributor 18 adds graphic information that renders a weather map for display on a display device 27 connected to cable network 20, or audio information that renders a computer synthesized voice speaking the contents of the weather message for output on audio device 27; other forms of supplemental information are to be selected based on the preferences of program distributor 18. For example, the supplemental information selected is related to the geographic region of an intended alert and the alarm class (the type of alarm being issued) such as a weather alert, terrorism alert, a missing person alert, and the like.

Advantageously, a program distributor 18 that acts as an alert author is able to notify users without warning device about an impending alert condition. Correspondingly, users with a warning device also benefit from the supplemental information added to an alert message from program distributor 18 when rendered on an audio and/or visual device 27.

In another embodiment of the present invention, alert messages are obtained and inserted at a cable system, for example from local broadcast signal 16. The program distributor 18 first receives one or more alert messages. These messages may come from several sources, including monitoring the over-the-air National Weather Service Broadcasts, or possibly through a connection to the EMWIN network directly, via the Internet or otherwise. The program distributor 18 then separates a key message, e.g., the SAME information from the other information.

This SAME message is then inserted as additional data into the data stream of a channel by appending and inserting an identifier PID (Program Identifier) into the digital transmission following the appropriate format rules for the signal. The PID may be established through a program guide function, as a predefined fixed number or by other techniques.

This PID is used in receiver 26 to determine what kind of information has been received. In this case, the PID identifies the information as an alert message, not a video or audio signal, and sends this information to the receiver's alert message identifier in receiver 26 and discriminator 32 (FIG. 1) for processing. The small size of the alert message makes it easy to insert into all program channels relatively simultaneously. Furthermore, the signals can be sent over digital networks. Other embodiments for use with analog signals using VBI insertion are also envisioned in a similar manner.

Receiver 26 may include a set top box, a television, a computer, a radio device, a cable or telephone modem or any other device equipped to relay warning information to a user. Since each home 24 may include a different receiver device or different setup, it is likely that, for a cable system, the data will need to be sent in a number of ways over a number of channels to ensure that all homes can and do receive the information.

Advantageously, since cable network 20 is usually regionally operated, hence program distributor 18 has to select which alert message(s) are rendered for the viewing area being serviced. This may be done manually or automatically depending on the method of receiving the information at program distributor 18. For example, the messages received at the headend network may be encoded as to which areas would be affected by the event. Alternately, once received, the information may be encoded at the program distributor 18 based on the locality to be alerted of the event. The total amount of data sent is quite small for a typical alert message; therefore, it is not anticipated that a significant loss of channel bandwidth will occur.

FIG. 3 shows an example of a VBI insertion for transferring a signal to a cable network using an analog format. VBI data is preferably input at the source of the signal. Signal 300 shows a Line 21 set-up for sending a message using, for example, a closed captioning system to transfer alert data in accordance with the present invention. This is known as the vertical blanking interval (or VBI). In the vertical blanking interval, there are typically 40 horizontal lines (these lines are above and/or below the edge of the picture screen and do not contain video information). Line 21 has been designated as the insertion point for closed captioning information. There are other insertion modes, e.g., teletext, XDS, etc., which all use these lines (more of them) typically somewhere between 5 and 25. Hence, the phrase “line 21”.

The SAME message can be inserted two characters (Character One and Character Two in FIG. 3) at a time (directly) into the VBI. It may take 25-30 of these, for example, to send the entire message, which is less than 1 second of real time (the VBI occurs 60 times a second). This message can be inserted several times, and still not impact the conventional closed caption operation.

There are several Electronics Industry Alliance (EIA) specifications that can govern operation in the VBI as known in the art, for example EIA608 specification titled “LINE 21 DATA SERVICES” (original specification for closed captioning), or EIA746 specification titled “TRANSPORT OF INTERNET UNIFORM RESOURCE LOCATOR (URL) INFORMATION USING TEXT-2 (T-2) SERVICE” (enhancements for interactive capabilities). There are products available both in hardware and software that allow VBI insertion capabilities (either for direct closed captioning or for augmenting the closed captioning). Using available devices, the VBI is employed to transfer warning data to a cable box or other device. Once the data is retrieved, it may be decoded and analyzed to determine if the information is appropriate for the present geographic location. If the information is appropriate with the location in question, the information is rendered for display and/or a warning alert is activated.

In a digital format, the opportunities are not nearly as restrictive in the analog format. One approach may include a digital format version for a VBI insertion. (See e.g., EIA746).

Alternately, the data can be entered as auxiliary data with its own PID. The advantage here may be that this PID can be separately managed by the provider and may avoid potential issues with other formatting systems and that the data need be sent only once per transponder. One approach would be to use SMPTE (Society of Motion Picture Television Engineers) standards for serial bit stream video (SMPTE292 titled “ TELEVISION—BIT-SERIAL DIGITAL INTERFACE FOR HIGH-DEFINITION TELEVISION SYSTEMS” is the top level specification). SMPTE 291 titled “TELEVISION—ANCILLARY DATA PACKET AND SPACE FORMATTING” specifies the format and method for insertion of ancillary data into a data stream. This data packet could be encapsulated within a valid MPEG transport packet for transmission across a digital cable or digital satellite network.

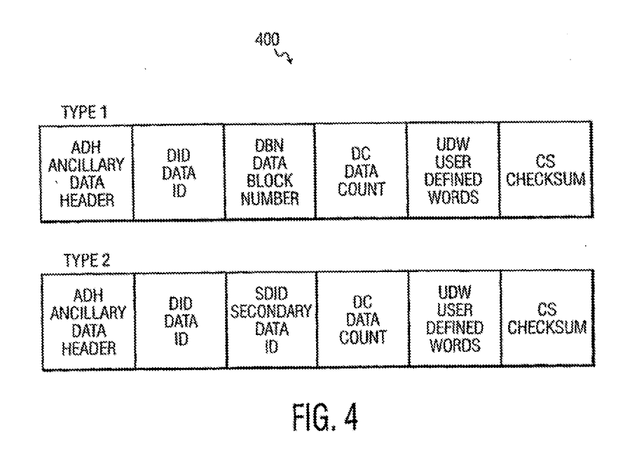

FIG. 4 shows one example for transferring a signal to a cable network using a digital format. Data format 400 shows a SMPTE format where Type 1 or Type 2 packets may be used. An Ancillary Data Header (ADH) functions to route the data to an appropriate destination. Data ID (DID) can be pre-defined through SMPTE to indicate alert data for display (SMPTE keeps the registry of Data IDs). In this way, a packet sent in an audio or video stream can be identified, removed and processed by discriminator 32 to provide an alert warning and message. The Data Block Number (DBN) is used to string multiple packets together. This may not be needed for this data string so a value of “0” can be used. The Data Count (DC) indicates a number of bytes (in the present case, somewhere around 50). The data would then be inserted in a User Data Word (UDW) slot. A Check Sum (CS) may be computed to provide error detection for the packet. Advantageously, the entire message can be sent in a single packet. There is a plurality of other methods for sending this data through a digital stream. Type 2 packets including a Secondary Data ID (SDID) may also be employed with type 1 packets to convey additional information or to route messages to different device (e.g., a warning device/alarm) in a receiver 26.

Referring back to FIG. 1, Receiver 26 provides information received from program distributor 18 to a user's audio or video rendering device 27, which may include a warning device 30. Warning device 30 may also be included as part of receiver 26 or externally connected to receiver 26. Receiver 26 preferably discriminates or decodes the encoded information received from program distributor 18 to provide information to localities, which would benefit from the information.

One useful operation of receiver 26 arises when receiver 26 is employed for its originally intended mode of operation, e.g., as a television, In this case, receiver 26 receives a signal for display on a television, and this signal is not a re-broadcast of a local transmission over an air station. Most over-the-air stations provide local weather and public safety alert information as an addition to or as preemption to normal program material. However, stations that originate nationally, or stations created by a cable network (e.g., movie channels) will, in general, not include this information.

Once the information is introduced into program distributor 18 and sent into the cable system 20, receiver 26 discriminates this information and automatically preempts or inserts the warning information into the television display. That is, the television program may be preempted at particular localities in accordance with discriminated codes. This may also include data streaming or closed captioning across a portion of the screen of a television, for example. In addition, a picture in a picture (PIP) application may be initiated to convey the warning or alert. In this manner the cable system extends the features of the over-the-air broadcasts to potentially all stations that the cable system carries.

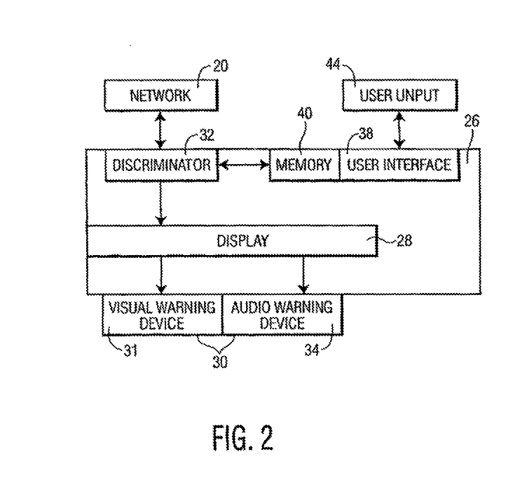

Referring to FIG. 2, receiver 26 is illustratively shown for alerting users of an event. Receiver 26 may include a set top box, or other devices, such as a radio, a telephone, a television, a cable modem, a telephone modem or other device capable of audio and/or visual display for warning a user. Receiver 26 includes an information discriminator 32. Receiver 26 includes a setup screen or display 28 to enable, for example a “weather-alert” feature. Within this screen 28, the user may be asked what types of alerts to be notified of and for what region of the country. Moreover, a user may specify the source of the alert preferred (e.g., from a local program distributor over a national broadcaster). This information may also be provided from the source or program distributor 18. Receiver 26 preferably includes warning device 30 which may further include one or more of display 28, a visual warning device 31 (e.g., a flashing light) and/or an audio warning device 34 (e.g., a speaker).

In accordance with one embodiment of the present invention, receiver 26 employs the system described by the current National Weather Service (NWS) VHF FM radio broadcast network that now utilizes the SAME (Specific Area Message Encoding) system. The SAME system permits for specific messaging to selected areas of a coverage region. Options exist at both a transmit end and a receive end of the system to specify which messages will be received. For example, program distributor 18 (FIG. 1) may discriminate which regions or regions will be read out on the display or be responsive to warning signals from specific regions. Alternately, receiver 26 may discriminate whether it is situated to receive a given message (e.g., receiver 26 is located in a specified locale).

The SAME system in NWS uses what are called FIPS (Federal Information Processing System) codes, which include coded words 6 bytes long. These words segment the United States into regions, states, and counties. In other embodiments, other defining encoding may be employed, for example, zip codes or even addresses of individual users. The user can select which messages are displayed by identifying the FIPS regions the user wants to be notified of. User interface 38, controlled by user input 44 may be employed to make the appropriate selections and/or program receiver 26. Given the regional operation of a cable system, a simpler or more complicated system may be employed. The cable receiver 26 may simply monitor the incoming messages from program distributor 18 and determine which messages to display based on user preferences, locale codes, date, time of day or any other criteria that can be programmed into the system. Predetermined criteria, e.g., FIPS codes, are programmed into receiver and compared to the encoded signals to determine if the information receive should be displayed and an alarm or alert mechanism activated.

In one embodiment, a user may be able to program a receiver memory 40 with one or more codes to receive information from program distributor 18. For example, a user may program locale codes for their office and home, or their present location and the location of a friend or relative. In an optional embodiment of the present invention, stock and/or bond codes or market indexes may be entered into receiver 26 to alert a user of the status of financial events. Personal or other information may be programmed into receiver 26 to permit a reminder warning or other indicator to be made to the user if the event occurs (e.g., a date event) or a condition is met (e.g., the temperature of a remote location reaches a certain value).

A number of options exist for displaying the message or information on display 28. For example, a banner, generated by the receiver, similar to a closed caption message could be inserted to indicate an “alert” state and/or information about the event or condition, which caused the “alert” state. Additionally the receiver could emit a beeping tone, or some other indicator on the receiver itself as described above. Advantageously, the “alert” state is provided at any time regardless of whether the user is viewing a particular channel or listening to a particular station. Receiver 26 is preferably always on and ready to provide an alert at any time in accordance with the present invention. The system 10 is easily implemented and easy to use to provide a means of communications alert for those people not immediately addressable by other local alert methods.

In one embodiment, warning device 30 includes different responses to different reports. For example, audio warning device 34 may include a plurality of prerecorded messages or may include a tone or sound, which designates a level of importance or immediacy of the report. Visual warning device 31 may include a plurality of indicators, such as lights, which may include different colors or flash at different rates or intensities to designate a level of importance or immediacy of the report. In other embodiments, the warning device 30 may include a software, a hardware or a combination of both to re-tune a device to a different pre-selected channel or station for a local off-air broadcast, which may relay information associated with the alert or the event. It is to be understood that warning device 30 may be included in receiver 26 or externally connected to receiver 26 by a wired or wireless connection.

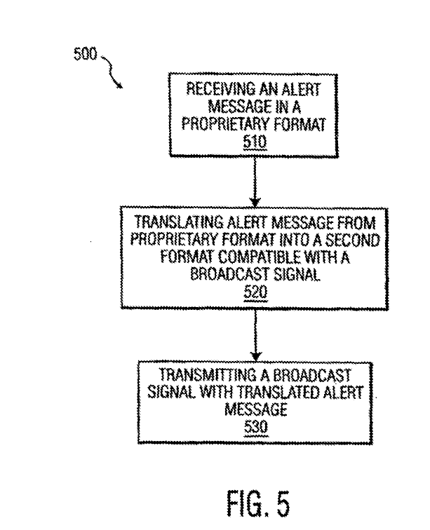

FIG. 5 discloses a flowchart of a method of translating an alert message into a format capable of being transmitted in a broadcast signal. Translation method 500 involves the operation of either information source 12 or program distributor 18 (see FIG. 1) receiving and translating an alert message, in accordance with the present principles of the present invention.

In an illustrative embodiment, program distributor 18 receives an alert message in step 510 where such a message is in a proprietary format. For example, program distributor 18 receives a SAME based alert for distribution to home users 24, although any format may be used, as known in the art. Information source 12, programming 14, local broadcast signals 16, and auxiliary information 22 are exemplary sources for the alert message.

Upon receiving the alert message, program distributor 18 optionally annotates information in the message. Typically, the received alert message may not have complete information (for example, the geographic code transmitted as part of the alert message may be incompatible with devices on data network). Program distributor 18 then adds the missing information, and/or deletes part of data comprising the alert message.

For example, an alert message received via local broadcast signal is a text alert pertaining to a geographic region. Program distributor 18 determines if the text alert should have audio and/or video information added because of the urgency of the text alert. In the present case, the text alert concerns an impending thunderstorm; the message comporting to an emergency notification standard, as explained above. Program distributor 18 adds a computer generated voice (as audio) to accompany the alert message, when transmitted to users 24, although other audio and video based information may be added as needed.

In step 520, program distributor 18 translates the alert message into a second format compatible with a broadcast signal, such a signal used to transmit broadcast programming. Examples of this process are explained in connection with FIG. 3 and FIG. 4. Preferably, program distributor 18 indicates that the translated message be rendered via warning device 30 for all viewed channels of programming, although such a rendering process may be selective to a subset of channels accommodated by a data network. For instance the alert message may only be transmitted for channels 1 to 5, where a cable system may accommodate channels 1 to 100.

Step 530 involves the transmission of the translated alert message to homes 24 via a broadcast signal. Hence, the alert message is transmitted via cable network to home where such a message is rendered by warning device 30 and/or audio/video device 27 at the point of home 24, where the standard broadcast signal for the cable system is used. It is appreciated that other modalities may be used to translate and transmit alert messages.

Having described preferred embodiments for weather/disaster alert system using a cable network (which are intended to be illustrative and not limiting). It is noted that modifications and variations can be made by persons skilled in the art in light of the above teachings. It is therefore to be understood that changes may be made in the particular embodiments of the invention disclosed which are within the scope and spirit of the invention.

What is claimed is:

1. A method for rendering an alert comprising:
receiving information comporting to an alert at a device;
receiving a plurality of user input selections comporting to when alerts should be rendered; and
rendering said information as an alert when said alert is of a type from a plurality of types of alerts where said type matches a first user input selection from said plurality of user input selections.

2. The method of claim 1 where said alert will be rendered when said information is from a source from a plurality of sources where said source matches a second user input selection from said plurality of user input selections.

3. The method of claim 2 where said alert will be rendered when said information has a geographic information from a plurality of geographic information where said geographic information matches a third user input selection from said plurality of user input selections.

4. The method of claim 3 where said alert where be rendered in a form in at least one of an alert shown on a display of said device, a flashing light of said device, and an audible warning from said device in response to a fourth user input selection from said plurality of user input selections.

5. A device for rendering alerts comprising:
a network connection that receives information comporting to an alert at a device;
a user interface that receives a plurality of user input selections comporting to when alerts should be rendered;
a memory that stores said plurality of user input selections;
a discriminator that determines that said information is to be rendered as an alert when said alert is of a type from a plurality of types of alerts where said type matches a first user input selection from said plurality of user input selections; and
a display that renders said alert when said discriminator determines that said alert is of said type that matches said first user input selection.

6. The apparatus of claim 5 where said discriminator determines when said information is from a source from a plurality of sources where said source matches a second user input selection from said plurality of user input selections, and said alert is rendered when said discriminator determines that said information is from said source matching said second user input selection.

7. The apparatus of claim 6 where said discriminator determines when said information has a geographic information from a plurality of geographic information where said geographic information matches a third user input selection from said plurality of user input selections, and said alert is rendered when said discriminator determines that said geographic information matches said third user input selection.
